(19) United States
(12) Patent Application Publication
(10) Pub. No.: US 2014/0174636 A1
(43) Pub. Date: Jun. 26, 2014

(54) METHOD FOR FABRICATING DECORATIVE COLORED GLASS

(71) Applicant: CHINA MOON ENTERPRISES LIMITED, KWUN TONG (HK)

(72) Inventors: KIN WAH SHIU, KWUN TONG (HK); KIN WAI SIU, KWUN TONG (HK)

(73) Assignee: CHINA MOON ENTERPRISES LIMITED, KWUN TONG (HK)

(21) Appl. No.: 14/098,082

(22) Filed: Dec. 5, 2013

(30) Foreign Application Priority Data
Dec. 24, 2012 (CN) 201210564684.9

(51) Int. Cl. B44F 1/06; B24B 1/00; C03C 27/10; C03C 17/28

(52) U.S. Cl. CPC B44F 1/06; C03C 17/28; B24B 1/00; C03C 27/10
USPC 156/101; 427/272

(57) ABSTRACT

Disclosed is a method for fabricating a piece of decorative colored glass, which comprises the following steps: covering a layer of protective film which has a pre-fabricated pattern that can be removed on a piece of glass; removing the pattern from the protective film; sand blasting the surface of the glass that the pattern is removed; cleaning the glass that is sand blasted; and coating oil on the surface of the glass where is sand blasted to obtain the decorative colored glass. The glass fabricated by the method of this invention can represent a stereoscopic impression through observation, which color may not be changed and discolored.

### TECHNICAL FIELD OF THE INVENTION

The present invention generally pertains to the art of producing a decorative pattern or design on the surface of glass, and more particularly, to a method for fabricating a piece of decorative glass by means of a sand blasting technique and oiling process.

### BACKGROUND OF THE INVENTION

In existing technology, a piece of sand blasting glass is formed by high-pressure injection of silicon carbide on the surface of the glass, which is later polished and ground so that the obtained sand blasting glass can be used for decoration, screen, interior partition wall, bathroom, furniture, door and windows to increase life sentiments. However, these pieces of sand blasting glass only be lightly processed on the surface, without any pattern thereon. Even if there is a pattern on the surface, it is only be colored on the surface by pad printing or screen printing. But the color of the colorful pattern of this glass may be changed or discolored due to long-term use. Also this colorful pattern may not represent a stereoscopic impression.

Therefore, there remains a need in the art to develop a novel method for sand blasting and coating oil on the glass, so as to obtain a decorative colored glass with beautiful and attractive appearance which can be used for a long time and cannot be discolored via long-term use, and can avoid the heretofore mentioned problems associated with the prior art.

### SUMMARY OF THE INVENTION

The present invention responds to the above need to provide a new method for fabricating a piece of decorative colored glass and the pattern of the obtained glass may represent a stereoscopic impression, which color may not be changed and discolored.

This object can be achieved by adopting the following technical solution:

a method for fabricating a decorative colored glass, comprising the following steps:

covering a layer of protective film which has a pre-fabricated pattern that can be removed on a piece of glass;

removing the pattern from the protective film;

sand blasting the surface of the glass that the pattern is removed;

cleaning the glass that is sand blasted; and

coating oil on the surface of the glass which is sand blasted to obtain the decorative colored glass.

According to one embodiment of the method of the invention, the protective film is obtained by drawing the pattern on the protective film and cutting the drawn pattern on the protective film by a vinyl cutter.

According to one embodiment of the method of the invention, the method further comprises the step of fixing the protective film on the glass by using a hot air gun after the protective film is covered on the glass.

According to one embodiment of the method of the invention, the step of sand blasting the surface of the glass can be processed by using a sand blasting machine which adopts pressure force of 5-7 bar, and dry compressed air having a flow rate of 0.8-1.2 m³/min.

According to one embodiment of the method of the invention, the sand blasting machine has a nozzle made of iron, which is cooperated with silicon carbide to perform the sand blasting. In one embodiment of the invention, the nozzle has a diameter of 4.5 mm.

According to one embodiment of the method of the invention, the step of cleaning the glass is processed by using an ultrasonic cleaning machine which contains a vibration head having a vibrating frequency of 28 KHZ or 40 KHZ.

According to one embodiment of the method of the invention, the ultrasonic cleaning machine uses a liquid trichloroethylene as transmission media for ultrasonic wave.

According to one embodiment of the method of the invention, the method further comprises a step of drying the cleaned glass after the glass is cleaned.

According to one embodiment of the method of the invention, the method further comprises a step of adhering at least two pieces of glass that is oiled on the surface.

According to one embodiment of the method of the invention, the step of adhering the glass is performed by coating colorless adhesive on the pattern that is sandblasted and oiled, curing the adhesive and followed by adhering said at least two pieces of glass by UV glue.

The method of the present invention improves the decorative glass in the prior art, which utilizes a protective film and sand blasting process to obtain a required pattern or design on the glass. That is to say, a pattern may firstly be formed on the protective film, then the pattern can be cut by a vinyl cutter, and the film should be fixed on the glass. The cut pattern is removed to represent the pattern on the glass, and the glass is sand blasted later. After that, the glass is cleaned to remove all the grease or other substance in a hidden place on the sand blasted glass, while keeping the glass undestroyed. Finally, the cleaned glass is coated oil and dried the oil to obtain the decorative colored glass of the invention. In the method, the pattern or design is drawn by a computer so that the pattern may become very delicate, beautiful and attractive. Moreover, for some small pattern, the cutting process is performed by a computer vinyl cutter to obtain an accurate result on the glass. In light of the above, the glass of the invention may have the following advantages:

1) the pattern or design representing a stereoscopic impression;

2) the pattern or design being delicate, beautiful and attractive; and

3) the color of pattern or design not being changed or peeled off.

### DETAILED DESCRIPTION OF THE INVENTION

The features of the present invention may be clearly set forth in the following description. The invention, together with the advantages thereof may be best understood by reference to the following description. And the method or the principle of the invention will be explained in detail. The description and explanatory embodiment herein are merely used to set forth the present invention, not to limit the invention.

The term “oil” used herein specifically refers to a kind of liquid oil with or without color, and the skilled in the art may apparently know that the term “oil” can be substituted by the term “paint”, provided that the paint coated on the surface of the glass achieve the same effect that the oil can achieve.

### EXAMPLE 1

The method of the present invention mainly comprises the following steps:

### 1) Selecting and Obtaining a Piece of Glass Which may Have an Appropriate Dimension

In terms of the strict requirement of fabricating the decorative colored glass, the glass commercially available needs to be cut for the sand blasting process and further coating oil. Specifically, for glass with different dimension, there is a need to firstly process the glass, for example, the glass having different depth may be sliced. In one embodiment, for those having a depth above 12 mm, a wet slicing process that is deemed a best and economic way, may be employed on the glass by using a slicer with diamond powder which has Φ 300×2 mm, and central hole-diameter of 25.4 mm. As those having a depth below 12 mm, a diamond cutter made in Japan may be used to cut the glass. The above processed glass may be polished by a grinding machine, straight line edging machine or a flat grinding machine to obtain the same height of surface on the glass. In one embodiment, the grinding machine and the flat grinding machine use a silicon carbide W40 material.

It is apparent for those skilled in the art that the color and shape of the glass can be selected freely according to the actual requirement.

### 2) Fabricating a Protective Film

A required pattern or design may be formed on a protective film by means of computer software such as Adobe Illustrator, in which the color code is Pantone formula book. The drawn pattern or design can be then cut by computer vinyl cutter to generate the required pattern or design on the film. If the pattern or design is too small, the line of the pattern or design may be enlarged first by a software such as Corel Draw so that the pattern or design can be attempted to process and find out if any problems exist, if no, mass manufacture of the film can be expected.

The protective film is made of plastics, for example, the film may be a PE film or PVC film.

### 3) Covering the Protective Film

The cut protective film can be covered appropriately on the surface of the glass and fixed accordingly. For example, a hot air gun can be served to blow hot air against the film so that the film can be fixedly covered on the surface of the glass.

### 4) Removing the Pattern or Design on the Protective Film

The pattern or design may be removed from the protective film so as to represent a glass surface for further sand blasting. Moreover, clean of the film is performed to remove entirely all the plastics granules that generated by removing the pattern or design, which may avoid the effect of sand blasting.

### 5) Sand Blasting the Pattern or Design on the Glass

The surface without protective film can be directed to sand blast by a sand blasting machine. The sand blasting machine is a foot-pedal sand blasting machine with a stable injection stream, which has pressure force of 6 bar (kg/cm²) and dry compressed air having a flow rate of 1.0 m³/min. Furthermore, this sandblasting machine has a nozzle made of iron which has a diameter of 4.5 mm, which is cooperated with silicon carbide to complete the sand blasting process of the required pattern or design.

### 6) Cleaning the Glass

After the glass is sand blasted, the glass may be needed to clean entirely. For example, the glass is cleaned by an ultrasonic cleaning machine via high-frequency ultrasonic vibration, which machine contains a vibration head having a vibrating frequency of 40,000/sec (40 KHZ) and uses a liquid trichloroethylene as transmission media for ultrasonic wave. Because ultrasonic wave belongs to longitudinal wave, it can render the pressure of trichloroethylene to be changed and converted into a quantity of tiny vacuum bubbles, which may generate cavitation effect. When the bubble is pressed, it may be exploited to generate a giant impact so that all the grease or other substance on the surface or in a hidden place on the glass can be totally removed immediately, while the glass may be remained undestroyed. At the same time, the oil that coated on the glass later may not be peeled off, spotted or bubbled on the surface of the glass.

### 7) Drying the Glass

Because the ultrasonic cleaning machine uses liquid trichloroethylene as transmission media for ultrasonic wave, the cleaned glass necessitates a drying step. For example, an oven can be used to dry the glass. It is apparent that any other drying device or means can be used to dry the glass for further process.

### 8) Oiling the Glass

After the glass is cleaned, the glass is coated oil accordingly. The oil may be colorful with a stable property so that the oil can be coated on the glass effectively. For example, the oil generally used in the invention may be low-temperature lead-free glass oil. The said oil has the advantages of saturated color, sufficient color scheme, high adhesion, fading resistance, good resistance to wind damage, anti-friction, anti-scratch, acid resistance, alkali resistance, alcohol resistance, sweat resistance, gasoline resistance and battery grade solvent resistance, and so on.

### 9) Drying the Oil on the Glass

The oiled glass may be dried in an oven for 15 minutes under a preferable temperature of 150° C. Alternatively, the oiled glass can be naturally cured in air, which, however, needs a longer time of 48 hours.

### 10) Removing the Remained Protective Film on the Glass

Finally, the remained protective film on the glass can be totally removed to obtain a decorative colored glass with a beautiful pattern that can represent a stereoscopic impression.

### EXAMPLE 2

The example comprises all the steps included in example 1, and it further comprises a step of adhering at least two pieces of oiled glass, for example, two or three pieces of glass can be adhered to form an integrated one. Specifically, the oiled pattern is coated with colorless and transparent viscous solution to form a protective oil layer that cannot react with UV glue, and the viscous solution on the pattern may be cured in room temperature for 24 hours, such as AH-510A. Then, the above two or three pieces of glass are adhered by UV (ultraviolet) glue to form an integrated one.

The above integrated glass in this example may be more beautiful and attractive than single one piece of oiled glass.

### EXAMPLE 3

This example is as the same as example 1, except that the sand blasting machine may have pressure force of 5 bar (kg/cm²) and dry compressed air having a flow rate of 0.8 m³/min in step 5), and the vibration head may have a vibrating frequency of 28,000/sec (28 KHZ) in step 6).

### EXAMPLE 4

This example is as the same as example 1, except that the sand blasting machine may have pressure force of 7 bar (kg/cm²) and dry compressed air having a flow rate of 1.2 m³/min in step 5), and the vibration head may have a vibrating frequency of 40,000/sec (40 KHZ) in step 6).

While the present invention has been described in terms of certain preferred embodiments and exemplified with respect thereto, one skilled in the art will readily appreciate that various modifications, changes, omissions and substitutions may be made without departing from the spirit thereof. It is intended therefore, that the present invention may be limited solely by the scope of the appended claim.

What is claimed is:

1. A method for fabricating a piece of decorative colored glass, comprising the following steps:
covering a layer of protective film which has a pre-fabricated pattern that can be removed on a piece of glass;
removing the pattern from the protective film;
sand blasting the surface of the glass in which the pattern is removed;
cleaning the glass that is sand blasted; and
coating oil on the surface of the glass which is sand blasted to obtain the decorative colored glass.

2. The method according to claim 1, characterized in that the protective film is obtained by drawing the pattern on the protective film and cutting the pattern on the protective film by a vinyl cutter.

3. The method according to claim 1, characterized in that the method further comprises the step of fixing the protective film on the glass by using a hot air gun after the protective film is covered on the glass.

4. The method according to claim 1, characterized in that the step of sand blasting the surface of the glass is processed by using a sand blasting machine which adopts pressure force of 5-7 bar, and dry compressed air having a flow rate of 0.8-1.2 m³/min.

5. The method according to claim 4, characterized in that the sand blasting machine has a nozzle made of iron, which is cooperated with silicon carbide to perform the sandblasting.

6. The method according to claim 1, characterized in that the step of cleaning the glass is processed by using a ultrasonic cleaning machine which contains a vibration head having a vibrating frequency of 28 KHZ or 40 KHZ.

7. The method according to claim 6, characterized in that the ultrasonic cleaning machine employs a liquid trichloroethylene as transmission media for ultrasonic wave.

8. The method according to claim 1, characterized in that the method further comprises a step of drying the cleaned glass after the glass is cleaned.

9. The method according to claim 1, characterized in that the method further comprises a step of adhering at least two pieces of glass that is oiled on the surface.

10. The method according to claim 9, characterized in that the step of adhering the glass is performed by coating colorless adhesive on the pattern that is sand blasted and oiled, curing the adhesive, and followed by adhering said at least two pieces of glass by UV glue.
